(19) United States
(12) Patent Application Publication
(10) Pub. No.: US 2012/0331469 A1
(43) Pub. Date: Dec. 27, 2012

(54) GRACEFULLY SHUTTING DOWN A COMPUTER PROCESS

(75) Inventors: James E. Van Peursem, Spring Grove, IL (US); Gerald J. Wehler, Twin Lakes, WI (US)

(73) Assignee: MOTOROLA MOBILITY, INC., Libertyville, IL (US)

(21) Appl. No.: 13/164,897

(22) Filed: Jun. 21, 2011

(51) Int. Cl. G06F 9/46

(52) U.S. Cl. 718/100

(57) ABSTRACT

A “buoy” process is associated with another “real” (i.e., non-buoy) process or application. Priorities are arranged so that, in a resource crisis, the buoy process is preferentially killed before its parent. When, during a crisis, the buoy is killed, its death is a signal to the parent process that it may be time to shut down gracefully. In some embodiments, when the parent process starts up, it launches a buoy process as its child. When the buoy process dies, the operating system sends a signal to the parent process. This signal warns the parent of the resource crisis. In other embodiments, a separate “guardian” process notes the existence of a new “parent” process, launches a buoy process, and associates the buoy with the “parent” process. The operating system informs the guardian if the buoy process is killed, and the guardian in turn informs the associated parent.

### FIELD OF THE INVENTION

The present invention is related generally to computer operating systems and, more particularly, to controlling resources in an operating-system environment.

### BACKGROUND OF THE INVENTION

Computing devices are being called upon to run more user applications and to perform more tasks, usually simultaneously, than ever before. To support this increased load, new devices are being built with access to ever greater amounts of internal and external resources (e.g., fast processing, large amounts of internal and external memory, and fast network access).

However, it still occasionally happens that a computing device is called on to perform more work than it can possibly support with its current set of resources. Often, the device knows that a resource shortage is approaching and can take steps to gracefully reduce the amount of work it is doing. When a resource shortage is imminent, the least important processes are told to shut down and to release the resources assigned to them. These released resources are then re-allocated to support more important processes. Given adequate warning, these least important processes can shut down “gracefully,” that is, they can store vital information (usually to long-term memory) so that the work they have been doing can be resumed later without waste. The users of the computing device can also be told of the imminent resource shortage and can take appropriate actions.

The above “graceful” process shutdown is not always possible in current operating-system environments, however. A resource shortage can arise so quickly that the device needs to reclaim resources immediately without taking the time to allow processes to gracefully shut down. For example, some current operating systems run a “low-memory killer” system. Each process running on the device is assigned a special “memory-killing” priority level. When a memory-resource crisis emerges suddenly, the least important processes are “killed” immediately. (They are sent a SIGKILL signal.) Their memory and other resources are released and are re-used to support the more important processes, but the killed processes are not given any time to store their state. Their most recent work cannot be backed up, and the user may be alarmed to see his processes disappear without warning.

When the resource crisis is passed, the killed processes can be restarted, but some of the work they were doing may be lost and must be performed again. Of course, if several recently killed processes are restarted simultaneously and are trying to “catch up,” this can lead to a new resource shortage.

### BRIEF SUMMARY

The above considerations, and others, are addressed by the present invention, which can be understood by referring to the specification, drawings, and claims. The present invention introduces the concept of a “buoy” process. The buoy process is a very light-weight process (in most embodiments it does nothing whatsoever) that is associated with another “real” (i.e., non-buoy) process or application. (For purposes of the present discussion, this “real” process is called the “parent” of the buoy, although, in certain embodiments, it is not actually the parent of the buoy process. The possibilities are explained below.) Priorities are arranged so that, in a resource crisis, the buoy process is preferentially killed before its parent. When, during a resource crisis, the buoy is killed, its death is a signal to the parent process that it may be time to shut down gracefully.

In some embodiments, when the parent process starts up, it launches a buoy process as its child. Current operating systems are usually set up to send a signal to a parent process when its child process dies (e.g., a “SIGCHILD” signal). In these embodiments, it is this signal that warns the parent of a resource crisis.

Other embodiments are designed to work even with legacy processes that are unaware of the concept of the buoy process. In these embodiments, a separate “guardian” process is running When the guardian notes the existence of a new “parent” process, the guardian launches a buoy process and associates the buoy with the “parent” process. (Note this terminology: Technically speaking, the actual parent of this buoy is the guardian process, but in the present discussion the process associated with the buoy is called the buoy's parent.) As with the embodiments described above, priorities are set so that during a resource crisis the buoy is killed before its associated parent. When that happens, the operating system informs the guardian, and the guardian in turn informs the associated parent. The parent, again, is given the opportunity to shut down gracefully.

In some embodiments, a single buoy process can be associated with multiple parent processes that should all be shut down together.

Aspects of the present invention are very general and may be implemented to warn of any type of condition. Some example conditions include low-memory, battery-charge level, location proximity, heat level, processor load, availability of a peripheral device, quality of a network connection, and availability of a network connection.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic of an exemplary computing device usable with the present invention;

FIG. 2 is a schematic of an exemplary memory environment illustrating aspects of the present invention;

FIG. 3 is a flowchart of a first exemplary method for gracefully shutting down a computer process; and

FIG. 4 is a flowchart of a second exemplary method for gracefully shutting down a computer process.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

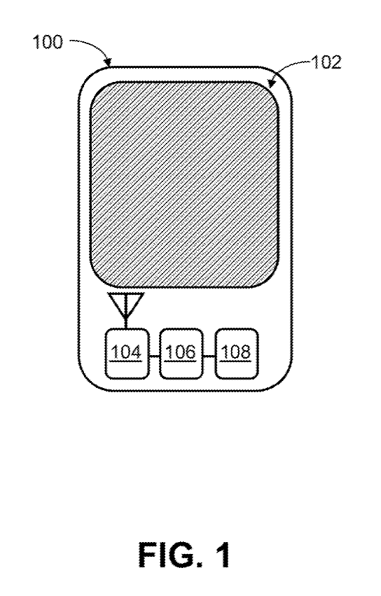

FIG. 1 shows a representative computing device 100 (e.g., a mobile telephone, personal digital assistant, tablet computer, personal computer, or server) that incorporates an embodiment of the present invention. FIG. 1 shows the device 100 as a cellular telephone presenting its main display screen 102 to its user. Typically, the main display 102 is used for most high-fidelity interactions with the user. For example, the main display 102 is used to show video or still images, is part of a user interface for changing configuration settings, and is used for viewing call logs and contact lists. To support these interactions, the main display 102 is of high resolution and is as large as can be comfortably accommodated in the device 100. In some situations, it would be useful for the user to have access to a display screen even larger than the main display 102. For these situations, a larger external display can be connected to, and controlled by, the computing device 100 (e.g., through a docking station). The device 100 may have a second and possibly a third display screen for presenting status messages. These screens are generally smaller than the main display screen 102.

The typical user interface of the computing device 100 includes, in addition to the main display 102, a keypad and other user-input devices. The keypad may be physical or virtual, involving virtual keys displayed on a touch screen 102.

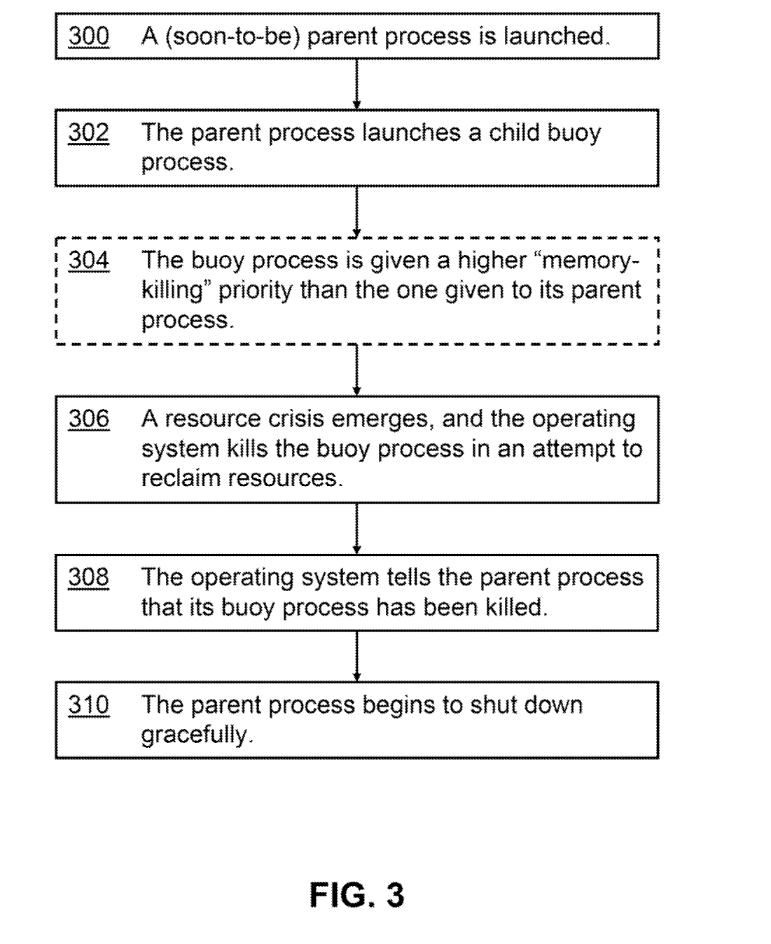

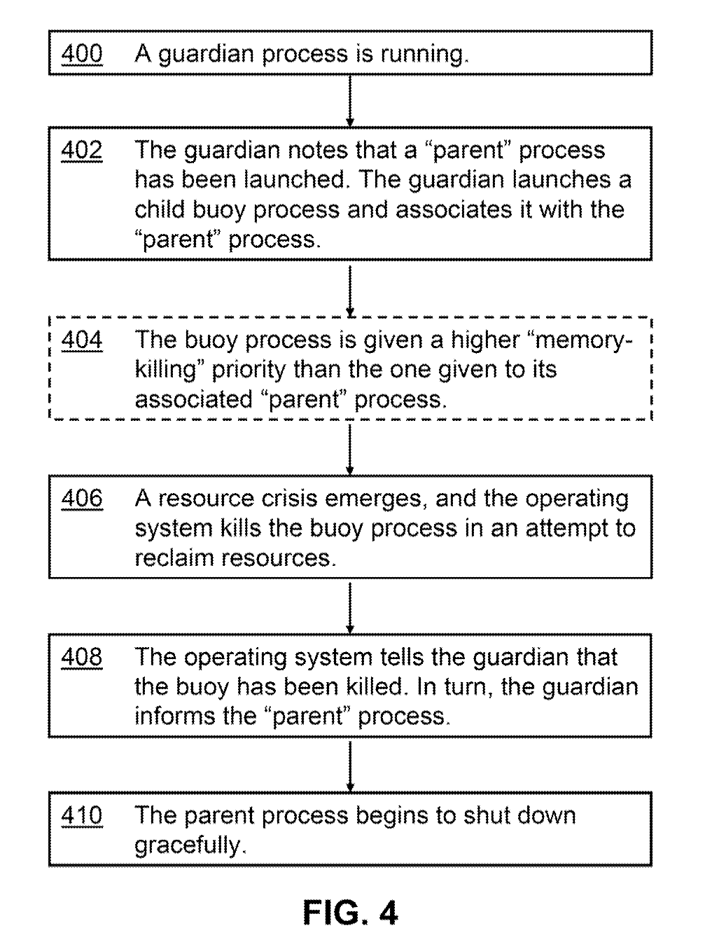

FIG. 1 illustrates some of the more important internal components of the computing device 100. The network interface 104 sends and receives media presentations, related information, and download requests. The processor complex 106 (which includes one or more processors) controls the operations of the device 100 and, in particular, supports aspects of the present invention as illustrated in FIGS. 3 and 4, discussed below. The processor complex 106 uses the memory 108 in its operations. Specific uses of these components by specific devices are discussed as appropriate below.

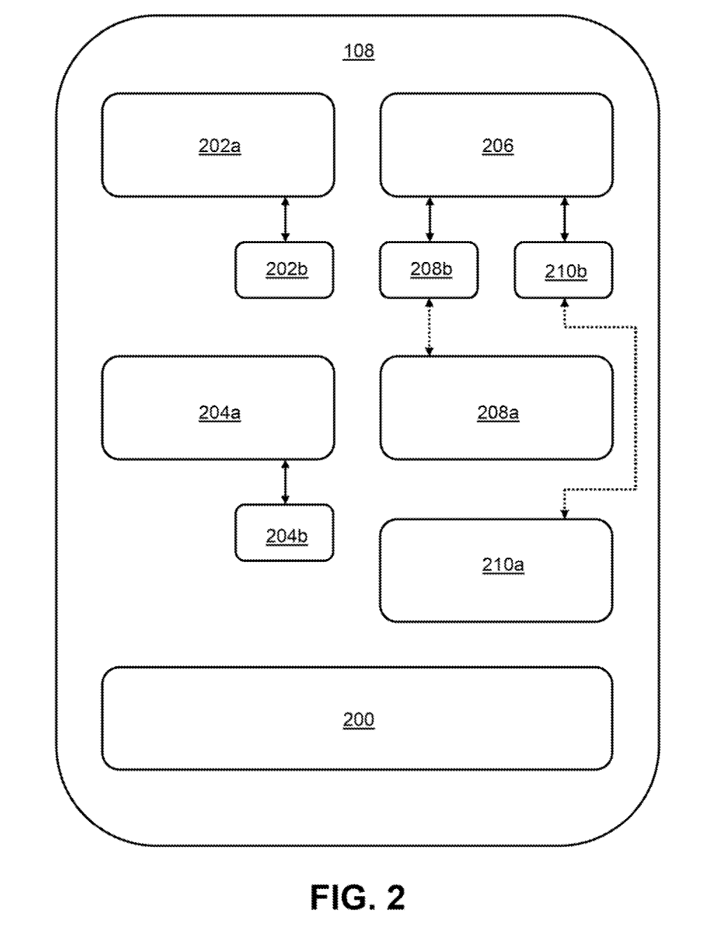

FIG. 2 is a highly abstracted view of the memory 108 of the computing device 100. Because aspects of the present invention are intended to work in any computing environment, details of memory-management (e.g., long-term vs. short-term memory storage, remote-storage schemes) and of processor arrangements (e.g., one or multiple processors, cloud computing) are intentionally left out of FIG. 2.

At least one operating system 200 occupies some of the memory 108. Also shown are processes 202a, 204, 208a, and 210a. These processes may be of almost any type and could include user applications, support processes, and utility programs.

The two processes 202a and 204a on the left of FIG. 2 illustrate a first embodiment of the present invention. This embodiment is further illustrated by the method of FIG. 3. This method begins in step 300 when a process (e.g., 202a or 204a) is launched. In this embodiment, these processes 202a, 204a are written to directly take advantage of aspects of the present invention. They begin to do so in step 302 when each launch a child buoy process. In FIG. 2, the process 202a has launched the buoy process 202b, and the process 204a has launched the buoy process 204b. By launching buoy processes, the processes 202a, 204a have become the parent processes of these buoys 202b, 204b, respectively. The buoy processes 202b, 204b are as minimal as possible, consuming very little memory and practically no computational resources.

Step 304 is optional because it illustrates aspects that are only supported by some operating systems. In this step, each of the parent processes 202a, 204a and each of the buoy processes 202b, 204b is assigned a “memory-killing” priority. The higher its memory-killing priority, the sooner a process will be killed to free up its resources during a memory-resource crisis. In this case, each buoy process 202b, 204b is assigned a higher memory-killing priority than that assigned to its respective parent process 202a, 204a.

A memory-resource crisis emerges in step 306. (As stated above, the methods of the present invention can be applied to conditions other than a memory-resource crisis. Step 304 is altered to fit the condition being protected against.) The operating system frees up resources by killing processes, beginning with those assigned the highest memory-killing priorities. Because of the assignments in step 304 (or their equivalents for other conditions), a buoy process 202b, 204b is killed by the operating system before the operating system gets around to killing the associated parent process 202a, 204a.

When an operating system kills a process, it usually informs the parent of the killed process of that fact (e.g., by sending a SIGCHILD signal). This occurs in step 308. With this warning that a crisis is at hand, the parent processes 202a, 204a may have time, in step 310, to shut down gracefully.

The present invention cannot guarantee that the parent processes 202a, 204a are given enough time in step 310 to complete their graceful shut-downs. The actual result depends upon how quickly the resource crisis develops and how much work the parent processes 202a, 204a need to do during the shut down. At the very least, the parent processes 202a, 204a are warned and begin to save their most critical data.

Note that the method of FIG. 3 does not require any change to existing operating systems. Once the buoy processes 202b, 204b are launched in step 302 and the memory-killing priorities (or their equivalents) are set up by the parent processes 202a, 204a in step 304, the operating system automatically fulfills its role in steps 306 and 308 (assuming, of course, that a resource crisis actually occurs).

However, the method of FIG. 3 does depend upon the parent processes 202a, 204a being aware of aspects of the present invention so that they can perform the actions of steps 302 and 304. A second embodiment of the present invention, illustrated in FIG. 4, treats “legacy” processes that do not know how to fulfill the expectations made of them in the method of FIG. 3.

The method of FIG. 4 begins in step 400 where a “guardian” process is running This method is illustrated by the processes on the right side of FIG. 2 where the guardian process is labeled 206. When they were launched, the two processes 208a and 210a did not launch child buoy processes (probably because they did not know how to). To provide these processes 208a, 210a with the benefits of the present invention, the guardian 206 notes that these processes 208a, 210a were launched (in step 402) and launches a buoy process for each of them. From the point of view of the operating system 200, these buoy processes 208b, 210b are the children of the guardian 206. However, the guardian 206 associates these buoy processes 208b, 210b with the processes 208a, 210a, respectively (possibly via a look-up table controlled by the guardian 206). Thereafter, the processes 208a, 210a become, for the purposes of the present discussion, effectively the “parents” of the buoy processes 208b, 210b, respectively. Because these buoys 208b, 210b are not in fact children of the processes 208a, 210a, the links between these buoys and their respective “parent” processes are show as dashed lines in FIG. 2.

Optional step 404 parallels optional step 304 of FIG. 3, except that in the method of FIG. 4, it is the guardian 206 that assigns the memory-killing priorities (or their equivalents).

When the resource crisis emerges in step 406, the operating system acts exactly as it did in step 306 of FIG. 3: The buoy processes 208b, 210b are killed, and, in step 408, the parent of the buoys 208b, 210b is informed of this fact. The only significant difference is that, in the method of FIG. 4, the parent is the guardian 206. The guardian 206 then signals the associated “parent” processes 208a, 210a, and, in step 410, these parent processes 208a, 210a attempt to shut down gracefully.

In some situations, it may be useful to have one buoy process associated with a group of parent processes, if the processes in that group should all be shut down at one time. In some situations, multiple buoy processes (e.g., one for each of several different conditions) can be associated with the same parent process.

In view of the many possible embodiments to which the principles of the present invention may be applied, it should be recognized that the embodiments described herein with respect to the drawing figures are meant to be illustrative only and should not be taken as limiting the scope of the invention. For example, different operating systems implement different methods for launching child processes and for signaling among them. Therefore, the invention as described herein contemplates all such embodiments as may come within the scope of the following claims and equivalents thereof.

We claim:

1. In a computing environment, a method for allowing a parent process to shut down gracefully, the method comprising:
launching, by the parent process, a buoy process as a child of the parent process;
receiving, by the parent process, a signal associated with the buoy process; and
based, at least in part, on receiving the signal, shutting down by the parent process.

2. The method of claim 1 wherein the received signal is a SIGCHILD signal.

3. The method of claim 1 wherein an operating system sends the signal upon killing the buoy process.

4. The method of claim 3 wherein the operating system kills the buoy process in response to a condition selected from the group consisting of: low-memory, battery-charge level, location proximity, heat level, processor load, availability of a peripheral device, quality of a network connection, and availability of a network connection.

5. The method of claim 1 further comprising:
assigning to the buoy process a priority value higher than that assigned to the parent process.

6. The method of claim 5 wherein processes running in the computing environment with higher priorities are preferentially killed by an operating system when compared to processes running in the computing environment with lower priorities.

7. A computing device comprising:
a memory; and
a processor complex operatively connected to the memory and configured for:
running a parent process, the parent process configured for:
launching a buoy process as a child of the parent process;
receiving a signal associated with the buoy process; and
based, at least in part, on receiving the signal, shutting down.

8. The computing device of claim 7 wherein the processor complex is selected from the group consisting of: a single processor and a plurality of processors.

9. The computing device of claim 7 wherein the signal received by the parent process is a SIGCHILD signal.

10. The computing device of claim 7 wherein the processor complex is further configured for:
running an operating system, the operating system configured for sending the signal upon killing the buoy process.

11. The computing device of claim 10 wherein the operating system kills the buoy process in response to a condition selected from the group consisting of: low-memory, battery-charge level, location proximity, heat level, processor load, availability of a peripheral device, quality of a network connection, and availability of a network connection.

12. The computing device of claim 7 wherein the parent process is further configured for:
assigning to the buoy process a priority value higher than that assigned to the parent process.

13. The computing device of claim 12 wherein the processor complex is further configured for:
running an operating system, the operating system configured for preferentially killing processes running on the processor complex with higher priorities when compared to processes running on the processor complex with lower priorities.

14. In a computing environment, a method for a guardian process to allow a parent process to shut down gracefully, the method comprising:
launching, by the guardian process, a buoy process;
receiving, by the guardian process, a signal associated with the buoy process; and
based, at least in part, on receiving the signal, shutting down the parent process by the guardian process.

15. The method of claim 14 wherein the received signal is a SIGCHILD signal.

16. The method of claim 14 wherein an operating system sends the signal upon killing the buoy process.

17. The method of claim 16 wherein the operating system kills the buoy process in response to a condition selected from the group consisting of: low-memory, battery-charge level, location proximity, heat level, processor load, availability of a peripheral device, quality of a network connection, and availability of a network connection.

18. The method of claim 14 further comprising:
assigning to the buoy process a priority value higher than that assigned to the parent process.

19. The method of claim 18 wherein processes running in the computing environment with higher priorities are preferentially killed by an operating system when compared to processes running in the computing environment with lower priorities.

20. A computing device comprising:
a memory; and
a processor complex operatively connected to the memory and configured for:
running a parent process and a guardian process, the guardian process configured for:
launching a buoy process;
receiving a signal associated with the buoy process; and
based, at least in part, on receiving the signal, shutting down the parent process.

21. The computing device of claim 20 wherein the processor complex is selected from the group consisting of: a single processor and a plurality of processors.

22. The computing device of claim 20 wherein the signal received by the guardian process is a SIGCHILD signal.

23. The computing device of claim 20 wherein the processor complex is further configured for:
running an operating system, the operating system configured for sending the signal upon killing the buoy process.

24. The computing device of claim 23 wherein the operating system kills the buoy process in response to a condition selected from the group consisting of: low-memory, battery-charge level, location proximity, heat level, processor load, availability of a peripheral device, quality of a network connection, and availability of a network connection.

25. The computing device of claim 20 wherein the parent process is further configured for:
assigning to the buoy process a priority value higher than that assigned to the parent process.

26. The computing device of claim 25 wherein the processor complex is further configured for:
running an operating system, the operating system configured for preferentially killing processes running on the processor complex with higher priorities when compared to processes running on the processor complex with lower priorities.
